(19) United States
(12) Patent Application Publication
(10) Pub. No.: US 2025/0038879 A1
(43) Pub. Date: Jan. 30, 2025

(54) METHOD AND SYSTEM OF EVALUATION OF AUDIO DEVICE SUSCEPTIBILITY TO ULTRASONIC ATTACK

(71) Applicant: Intel Corporation, Santa Clara, CA (US)

(72) Inventors: Pawel Trella, Gdansk (PL); Przemyslaw Maziewski, Gdansk (PL); Damian Koszewski, Gdansk (PL); Jan Banas, Gdansk (PL); Piotr Klinke, Szczecin (PL); Maciej Kuklinowski, Gdansk (PL)

(73) Assignee: Intel Corporation, Santa Clara, CA (US)

(21) Appl. No.: 18/225,370

(22) Filed: Jul. 24, 2023

(51) Int. Cl. H04K 3/00

(52) U.S. Cl. CPC H04K 3/42; H04K 2203/12

(57) ABSTRACT

A system, article, device, apparatus, and method of audio processing comprises receiving, by processor circuitry, audible audio signal data of intermodulation distortion products (IDPs) based on ultrasonic audio signals received by at least one microphone of an audio device. The method also compares the audible audio signal data to ultrasonic audio signal data of the ultrasonic audio signals. Thereafter, the method determines a plurality of susceptibility values each of a different ultrasonic frequency based on the comparing, wherein the plurality of susceptibility values represent an ultrasonic attack susceptibility of the audio device.

### BACKGROUND

Audio speech recognition enabled devices, such as smartphones, smart speakers, home management systems, and so forth, perform actions in response to spoken user requests and commands. These devices are vulnerable to ultrasonic attacks where the speech enabled device receives ultrasonic sound waves that are inaudible to humans, but unintentionally converts the ultrasonic sound waves into audible audio signal data due to intermodulation distortion. The resulting intermodulation distortion products can be inadvertently analyzed by a speech recognition application as normal speech coming from a user, and cause the audio device to act on commands embedded in the intermodulation distortion products without the user's knowledge. The commands may be used for malicious purposes such as identity theft, data or home security breaches, and other unauthorized acts.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an example ultrasonic attack capture system according to at least one of the implementations disclosed herein;

FIG. 2 is a schematic diagram of an example audio processing system to generate ultrasonic attack audio signals according to at least one of the implementations disclosed herein;

FIG. 3 is a schematic diagram of an example audio processing system to evaluate ultrasonic attack susceptibility of an audio device and according to at least one of the implementations disclosed herein;

FIG. 4 is a flow chart of an example method of evaluating audio device susceptibility to ultrasonic attack according to at least one of the implementations disclosed herein;

FIGS. 5A-5B is a detailed flow chart of an example method of evaluating audio device susceptibility to ultrasonic attack according to at least one of the implementations disclosed herein;

FIG. 6 is a graph showing an example ultrasonic audio signal format used to generate an ultrasonic attack according to at least one of the implementations described herein;

FIG. 7 is a graph showing a close-up of the example ultrasonic audio signal format of FIG. 6 and according to at least one of the implementations described herein;

FIG. 8 is a graph showing example ultrasonic audio signal frequency spikes from an ultrasonic attack according to at least one of the implementations described herein;

FIG. 9 is a graph showing example intermodulation distortion product frequency spikes from an ultrasonic attack according to at least one of the implementations described herein;

FIG. 10 is a graph showing example differences between audio signals of the ultrasonic frequency spikes and the intermodulation distortion product frequency spikes according to at least one of the implementations described herein;

FIG. 11 is an image of a spectrogram showing sound pressure level on a map of fixed ultrasonic frequency by difference between the fixed ultrasonic frequency and variable ultrasonic frequency according to at least one of the implementations described herein;

FIG. 12 is a graph showing a mapping of mean sound pressure level versus frequency from the spectrogram of FIG. 11 and according to at least one of the implementations described herein;

FIG. 13 is an illustrative diagram of an example system;

FIG. 14 is an illustrative diagram of another example system; and

FIG. 15 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as servers, network or cloud computers, laptop, desktop, or other personal (PC) computers, tablets, mobile devices such as smart phones, smart speakers, or smart microphones, conference table console microphone(s), video game panels or consoles, high definition audio systems, surround sound, or neural surround home theatres, television set top boxes, on-board vehicle systems, dictation machines, security systems, Internet of things (IoT) devices, home or building management systems, and so forth, may be used to implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

As used in the description and the claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

Systems, articles, platforms, apparatuses, devices, and methods for evaluation of audio device susceptibility to ultrasonic attack.

Ultrasonic attacks are particularly devious because a person using a listening or speech enabled audio device cannot hear ultrasonic attack signals with embedded commands since the range of human hearing is about 20 Hz to 20 kHz, and ultrasonic signals have higher frequencies but are still captured by typical microphones. Particularly, the ultrasonic attack exploits the nonlinear characteristics of a microphone at ultrasonic frequencies. In detail, microphones are ideally linear where input sound received by the microphone should be directly proportional to output sound. Thus, in theory, when a gain is applied to an input signal, only the amplitude of the audio signal changes, but the frequencies remain the same. In reality, however, imperfections and manufacturing tolerances in the diaphragm and amplifier used by a microphone can cause non-linear behavior (or non-linearities) that results in additional unwanted frequency components (called intermodulation distortion products (IDPs)).

Non-linear microphones stimulated with inaudible ultrasonic frequencies can result in intermodulation distortion products of a number of different orders relative to initial ultrasonic frequencies. In the case of ultrasonic attacks, second order intermodulation distortion products can have frequencies in the audible frequency range. Particularly, an ultrasonic attack can have two components, an ultrasonic carrier (e.g., tone signal) at a first fixed frequency f₁, and an amplitude modulated speech signal transposed to an ultrasonic range. The speech signal is often modulated using the same carrier frequency and has a wideband that occupies a frequency spectrum of around the carrier +/−8 kHz, such that it is centered about a second frequency f₂. Once ultrasonic frequencies f₁ and f₂ are emitted from an attacker device, the nonlinearities in the microphones of a victim audio device cause the intermodulation distortion, which generates intermodulation distortion products (IDPs) of the ultrasonic carrier and the ultrasonic speech at both sum and difference frequencies f₂-f₁ and f₂+f₁ as the relevant second order products here. By choosing appropriate values for frequencies f₁ and f₂, the ultrasonic speech signal, and particularly f₂-f₁, may be frequency downshifted to a frequency range associated with normal human speech. In this case, such a distortion leaves a speech-like artifact of IDPs (or IDP spikes) in the base band of human speech. The artifact or IDP signal (or just IDP or IDP spike) is then processed by the device as if it is audible (or normal) human speech, even though it was never emitted or audible over the air. The term audible herein refers to sound or audio signals capable of being heard by a human and that has frequencies within the human hearing frequency range (e.g., an audible frequency band) whether or not a human is actually present to hear the sound (or in other words, hear the acoustic waves or audio signal).

Such an ultrasonic attack may be used to carry commands to cause interaction jamming, identity theft, unauthorized purchases, interference with home or vehicle smart systems, breaching of security systems, and many other undesired and damaging actions.

Defense mechanisms have been proposed to thwart these ultrasonic attacks. Some use jamming signals which require additional hardware and/or processing while the audio device is in use. Also, some conventional attack detection techniques are performed in the automatic speech recognition (ASR) domain, where a device can be tested against simulated attacks using false accept rate (FAR) metrics of resulting recognized speech. The FAR testing, however, is very time consuming due to both carrier frequencies and number of utterances per carrier frequency that needs to be tested. Specifically, the audio device needs to be tested across a wide range of ultrasonic carrier frequencies, and ideally across a range such as 20 kHz to multiple GHz. Also, each carrier frequency should be tested with at least tens to hundreds of utterances (if entire corpuses are too large to be practical) to better ensure that the audio device is adequately immune to ultrasonic attack.

Furthermore, testing using modulated speech signals requires that the audio device being tested already has an operational ASR system. Thus, the testing necessarily evaluates the ASR system itself as well as the microphone and the audio processing modules. This results in delay of the ultrasonic attack evaluation during the product development such that early form factors cannot be changed such as of the form of the microphone itself, the shape and form of the audio device housing around the microphone, and other related audio processing hardware.

To resolve these issues, the disclosed method and system provide a quantifiable measure or metric of device-specific ultrasonic attack susceptibility of an audio device that can be used to develop a protection scheme for a particular audio device since all devices respond to various attack frequencies differently. The susceptibility measure may be generalized for a type of microphone or type of audio device when such is deemed adequate for mass production.

The susceptibility measure or metric is an indication of the probability of success of an ultrasonic attack at particular carrier frequencies. Specifically, the susceptibility metric is a measure of the similarity between (1) the ultrasonic audio signals used for the attack (and more precisely, the ultrasonic audio signal data of those signals) and (2) audible intermodulation distortion product (IDP) audio signal data modulated from the same emitted ultrasonic audio signals and observable in the normal human hearing range. The ultrasonic signals are obtained from a reference microphone without amplification and filtering, and the IDP audio signal data is obtained by analyzing the IDPs to generate pseudo or equivalent audio signal features as if the IDP audio signals were actually emitted or broadcast in the air, even though no such audible audio signal was ever emitted. These pseudo or equivalent IDPs may be referred to herein as audible IDP audio signals with audible IDP audio signal data (or just audible audio signal data).

In more detail, a feature of the ultrasonic audio signal data can be compared to the same feature of the audible audio signal data. The smaller the difference between the features from the ultrasonic and audible audio signal data, the higher the probability of a successful ultrasonic attack at the specific carrier frequency being analyzed. By one form, this feature is sound pressure level (SPL), and the SPL for both the ultrasonic reference data and the audible data is obtained from signal power spectrums generated when the ultrasonic audio is separately captured on both a reference microphone and one or more microphones at an audio device being tested (device under testing or DUT). As to the audible audio signal data, two unmixed tones are emitted from a stimuli (or ultrasonic attack or attack) device as the ultrasonic attack stimuli or original ultrasonic audio signals. The SPL of the audible audio signal data is the SPL at a difference frequency or IDP frequency that is the difference in frequency between the two tone frequencies. The values of the two tone frequencies are selected to maintain a difference in frequency between them that is within the human audible range.

The result, by one example, is a susceptibility metric that is a level difference per carrier frequency, where the level difference is between ultrasonic signal SPL and equivalent audio intermodulation product signal SPL. The higher the susceptibility metric or value, the smaller the level difference, and the greater the probability of a successful attack. Thus, the larger the negative decibel value, the higher the probability of a successful ultrasonic attack. A minimum threshold may be developed where attack may not be a concern. By one example form, susceptibility greater than-30 dB for a carrier frequency has a high or significant probability of ultrasonic attack and should be addressed.

Once the susceptibility metrics are determined for a range of ultrasonic carrier frequencies, a device-specific simulated attack signal with a high probability of a successful attack can be reconstructed and more efficiently than a general-purpose simulated attack signal with a randomly selected carrier frequency. With the known susceptible ultrasonic attack carrier signals, an evaluation of defense mechanisms procedures can be developed efficiently to focus on the areas of greatest susceptibility instead of iterating across whole ultrasonic spectrums such as from 20 KHz to hundreds of kHz. This significantly reduces computational loads and time, and in turn power consumption, to perform ultrasonic attack testing on a device.

Also, since the testing described herein merely requires microphone recording capability rather than fully operational audio processing applications such as ASR, this permits a left-shifting process (or upstream along a production pipeline) so that form factor decisions that consider and minimize the susceptibility metric, and in turn the device-specific or device-type-specific ultrasonic attack susceptibility, can be made during hardware design stages. This may include changing the shape, position, or number of audio inlets on a microphone grill, the microphone housing shape, size, or material, and/or the audio device housing or audio inlets surrounding or covering a microphone to name a few examples. The result is improved security and privacy for the end users.

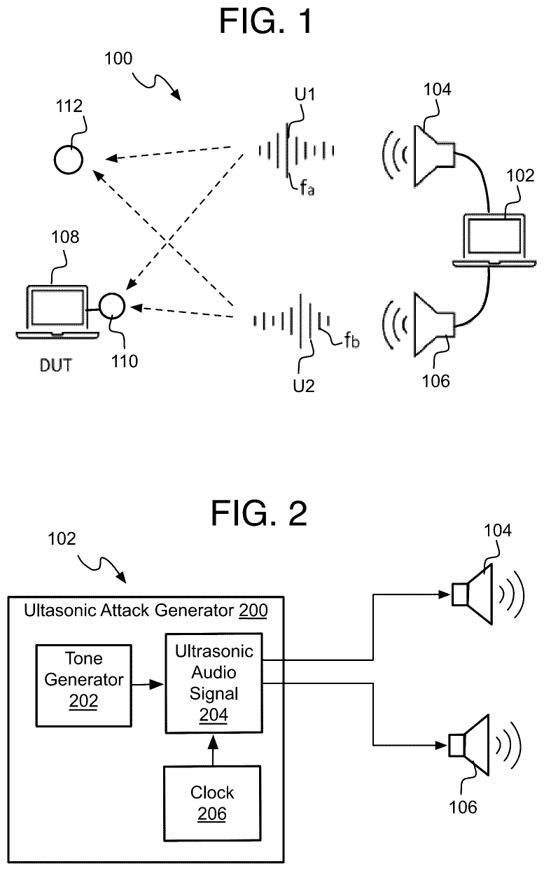

Referring to FIG. 1, an example audio processing setup or system 100 may be used to emit ultrasonic attack audio signals (or stimuli signals) at a stimuli (or attack) device and capture the signals at a device under testing (DUT) to perform the methods of ultrasonic attack evaluation described herein. System 100 may have a stimuli or tester (or simulated attack or attacker) device 102 with speakers 104 and 106, which also may be referred to as the attacker device even though no actual attack commands accompanies the tones. By one example form described below, ultrasonic audio including a carrier signal U1 with frequency fₐ and a speech signal U2 with frequency f_{b} are emitted separately and respectively from the speakers 104 and 106. Then, both signals U1 and U2 of the ultrasonic audio may be captured by both (1) one or more microphones 110 at a device under testing (DUT) 108, and (2) a reference microphone 112. The DUT microphones 110 may be internal microphones on the DUT 108 or may be external microphones that is either coupled through wires to the DUT 108 or is paired wirelessly to the DUT 108. The system 100 may be located in an anechoic chamber to achieve extremely low self noise within the ultrasonic frequency range being captured as well as to isolate the measured phenomenon to the highest degree possible, i.e. by avoiding reflections and reverberation.

The stimuli (or attacker) device 102 may have dedicated audio hardware such as a sound card and that may provide an interface and support high sampling rates, such as 48 kHz or higher. The type of attacker device may be a laptop, a mobile phone, portable music player, but otherwise is not limited as long as it has processor circuitry, audio playback capability with high sampling rates, and ultrasonic-capable loudspeakers to provide ultrasonic signals with two separate pure tones as described below.

The speakers 104 and 106 may be ultrasonic loudspeakers that have a frequency response upper cutoff frequency exceeding the upper cutoff frequency of human hearing (around 20 kHz).

The DUT 108 may be any speech enabled device, whether a smart device (such as a smartphone, smart speaker, and so forth), computer (e.g., laptop), IoT, and/or home or vehicle voice management system, and so forth.

The one or more DUT microphones 110 should be the type of microphones usually, or expected to be, on the DUT 108 device, such as digital or analog micro-electro-mechanical system microphones (MEMS microphones), miniature microphones or smart microphones. When multiple microphones 110 are on DUT 108, the system 100 may use or select one of the microphones, or the audio data of the multiple microphones may be combined (such as averaged) according to the normal use of the DUT microphones.

The reference microphone 112 should be a high quality measurement microphone or microphone set, with an upper frequency limit of a frequency response exceeding the upper frequency limit of human hearing (around 20 kHz), acoustic overload point above 80 dB SPL across all frequencies including ultrasonic, and intermodulation distortions below 1% below 80 dB SPL across all frequencies including ultrasonic. By one form, the reference microphone may be placed as close to the DUT microphone location as possible. Thus, more than one reference microphone 112 can be used when desired, such as to use separate corresponding reference microphones 112 with one each for each of the DUT microphones 110 if the DUT 108 has multiple microphones spaced away from each other.

Referring to FIG. 2, a stimuli (or ultrasonic attack) generator 200 at stimuli (or attack) device 102 may include tone generator unit or circuitry 202, ultrasonic audio signal unit or circuitry 204, and clock circuitry 206. Each ultrasonic signal U1 and U2 may be a pure tone respectively with U1 being at a fixed carrier frequency fₐ, and fixed for at least sections or groups of samples and of a total ultrasonic signal sequence. Also, the signal U2 may or may not be variable and as described in detail below. Thus, as an alternative, carrier and speech tone designations may not always be needed as long as at least two tones with different ultrasonic frequencies are emitted with the other parameters listed herein. The tone generator unit 202 obtains or has the ultrasonic signal format of the signals U1 and U2 to be emitted, while the ultrasonic audio signal unit 204 then generates the tones (or more precisely the data to have speakers 104 and 106 emit the tones). The tones are generated according to a clock 206 in order to setup the tones into samples in groups to be emitted where the carrier signal frequency fₐ is fixed in each group while being stepped from group to group and the speech signal frequency f_{b} varies within each group. This is accomplished by either generating the two channel test sequence programmatically in software, and then playing back the previously generated test sequence via digital-to-analog converter DAC, or by generating the tones individually by dedicated tone generation circuitry, either digitally (for example, generating signals in the digital domain and then converting to analog via DAC) or by analog generation (for example, direct sine tone generation using analog oscillator circuitry).

The tones U1 and U2 are emitted separately on the two speakers 104 and 106 so that intermodulation distortion only occurs at the DUT 108 rather than at the source or stimuli device 102 (or in other words, while in the air or while being transmitted or broadcast). In order to emit the ultrasonic signals U1 and U2 separately, the ultrasonic audio signal unit 204 may have two channel output, or the playback system can be constructed from two independent single-channel playback systems with synchronized clocks. By one form, the tones are both emitted at 70 dB_{20μPa}.

It should be noted that no actual embedding of speech commands is performed, which drastically simplifies the testing process, and in turn reduces the computational load and power consumption on both the emitting and receiving sides to perform the evaluations.

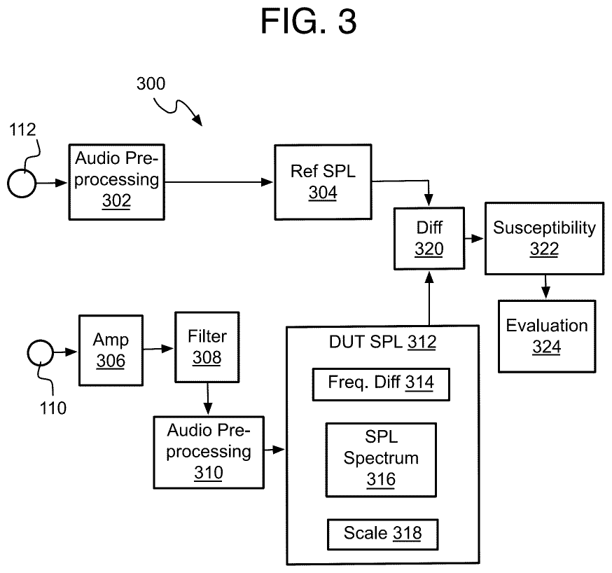

Referring to FIG. 3, an audio processing system may be an ultrasonic attack evaluation unit 300 and may have, or be communicatively connect to, the reference microphone 112 and DUT microphone 110. It will be appreciated that the ultrasonic attack evaluation unit 300 may be on the DUT audio device 108, but alternatively may be on the stimuli device 102, on any of the speakers or microphones when such devices have its own processing circuitry for such computations, or any other device that may be remote from the components of the ultrasonic attack evaluation unit 300, as long as it communicates wirelessly or through wires with the DUT 108 and reference microphone 112 to receive audio signals and/or audio signal data from those devices. By one form, the ultrasonic attack evaluation unit 300 is on a remote PC or remote server communicating over a WAN such as the internet with the DUT 108 and reference microphone 110. By another alternative, the evaluation unit 300 may be separated into modules or components on multiple different devices that communicate with each other as needed to perform the ultrasonic attack evaluation. Otherwise, a recording on the DUT 108 can be performed, then transferred to a remote PC via any possible file transfer method (whether pendrive (flash drive), LAN, and so forth). The results then can be calculated on a remote PC during offline analysis.

The ultrasonic attack evaluation unit 300 also may have an audio or ultrasonic pre-processing unit 302, a reference (or ultrasonic) SPL unit 304, an amplifier 306, a filter unit 308, an audio or audible pre-processing unit 310, a DUT SPL unit 312, a difference unit 320, a susceptibility unit 322, and an evaluation unit 324 as follows.

First on a reference side, reference ultrasonic data is obtained directly from ultrasonic signals via a reference microphone 112, rather than DUT 108 itself, because the DUT 108 has the filter unit 308 that, in most cases, will have an anti-aliasing filter with an upper cutoff frequency, such as a 16 kHz sampling rate, that filters out all ultrasonic signals. The term directly here refers to ultrasonic audio processing without amplification and/or filtering (and/or other pre-processing) that may drop or modify ultrasonic signals such that a sufficient or desired SPL version or value of the ultrasonic signal cannot be obtained for comparison to SPL of the IDP audible audio signal data.

The audio or ultrasonic pre-processing unit 302 may format the ultrasonic signals as desired for the testing and if not already performed by the reference microphone 110 itself. This may include analog to digital conversion (ADC) for example. It should be noted that other pre-processing that significantly modifies the initial ultrasonic audio signals should be avoided such as acoustic echo cancellation (AEC) and denoising since such operations can add or modify features that are not sufficiently duplicated by the IDP audio signals and in turn may erroneously affect the resulting susceptibility levels. Such unmodified ultrasonic audio signals (despite ADC) may be referred to as unprocessed or raw audio signals.

A reference or ultrasonic SPL unit 304 then may determine the SPL values L of the ultrasonic signals U1 and U2. The SPL L may be determined by spectrogram analysis and may be close to the stimuli emission level or SPL at the stimuli (or attacker) device 102 and that is sufficiently maintained in the captured ultrasonic audio signals at the reference microphone and the resulting ultrasonic audio signal data at the evaluation unit 300. By one example, the ultrasonic SPL L may be determined to be relatively near a stimuli device emission SPL set at 70 dB_{20μPa}.

Switching to the pseudo or equivalent audible IDP side, the amplifier 306, filter 308, and audio (and audible) pre-processing unit 310 generate the intermodulation distortion product spikes or frequencies and otherwise format the IDP spikes for ultrasonic attack evaluation. Specifically, the amplifier 306 of the unit 300, and in turn the DUT 108, as well as a diaphragm or other structure of the DUT microphone 110, will have imperfections that cause non-linearities and in turn the IDP spikes while the amplifier 306 is applying a gain to any received audio signals. The filter unit 308 then may have a low pass filter (LPF) and/or anti-aliasing filter that drops ultrasonic audio signals. The audible audio pre-processing unit 310 then may apply any desired pre-processing not already applied by microphone 110 itself, such as ADC. By one form, the otherwise raw unprocessed signals may be used for testing. Thus, as with ultrasonic audio pre-processing unit 302, here too any other unnecessary denoising, AEC, and so forth may be avoided to avoid modifying the audible IDP audio signal in a way that is not duplicated on the ultrasonic audio signals. The result is audible IDP audio signal data with a second order product or frequency that is a difference of frequencies fₐ and f_{b}. The resulting audible audio signal data including the audible IDP spike then may be provided to the DUT SPL unit 312.

The DUT SPL unit 312 may have a frequency difference unit 314, a SPL spectrum unit 316, and a scale (or sensitivity) unit 318. The DUT SPL unit 312 may receive the audible audio signal data as a continuous stream of audio samples at a rate (which here may be a fixed sampling frequency) of 48 kHz or lower. Then the signal may be analyzed for the IDP spikes by either analysis in the frequency domain by performing Short-Term Fourier Transformation STFT, or by analysis in the time domain by performing narrowband filtering on a differential frequency obtained from the difference unit 314.

The frequency difference (or differential) unit 314 of the DUT SPL unit 312 then will extract or read the differential frequency (or audible IDP frequency) from the received audio stream or samples. The SPL spectrum unit 316 then looks up the audible IDP frequency on a SPL spectrum map and reads the SPL in digital dB values (dBfs values). Thereafter, the scale (or sensitivity) unit 318 then converts the SPL in dBfs into equivalent in-air dB20 μPa scale for easier comparisons.

Once the audible or DUT SPL is scaled, the differencing unit 320 may determine a SPL difference value or version between the SPL of the audible IDP audio signal data and the ultrasonic audio signal data.

The susceptibility unit 322 then determines a susceptibility value or level of the DUT 108, and by one example, may determine a weighted average SPL difference for individual carrier frequencies fₐ being tracked, and as described below, that represents a probability (or likelihood or confidence) that an ultrasonic attack will be successful at the carrier frequency fₐ for the DUT 108 being analyzed.

The evaluation unit 324 then may compare the susceptibility value to a threshold or apply other criteria as desired to determine if the susceptibility value is sufficiently significant to warrant microphone design modifications or other defensive actions whether in software, hardware, firmware, or physical design of the DUT or audio device 108.

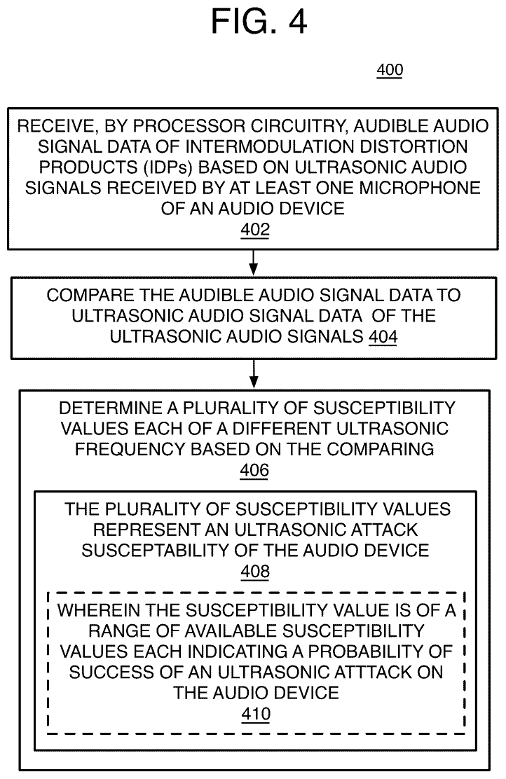

Referring to FIG. 4, an example process 400 to evaluate an audio device for ultrasonic attack susceptibility is provided. In the illustrated implementation, process 400 may include one or more operations, functions, or actions as illustrated by one or more of operations 402 to 410 at least generally numbered evenly. By way of non-limiting example, process 400 may be described herein with reference to example systems or system components 100, 200, 300, 1300, 1400, and 1500 of FIGS. 1-3 and 13-15, or any of the other systems, processes, data, or explanations described herein, and where relevant.

Process 400 may include “receive, by processor circuitry, audible audio signal data of intermodulation distortion products (IDPs) based on ultrasonic audio signals received by at least one microphone of an audio device” 402. As mentioned, ultrasonic audio signals are emitted, and by one form, as at least two tones, one being in a fixed carrier frequency at least for parts or sections of a complete ultrasonic audio emission sequence, and at least one other tone varying in frequency while the carrier frequency is fixed. This other tone is referred to herein as a speech tone since it represents a second ultrasonic signal that carries commands, even though no such command is present for the ultrasonic detection purposes herein. By one example, the two tones are emitted from separate speakers simultaneously. The ultrasonic audio emission may be constructed as groups of samples or iterations where each group has the carrier frequency fixed but increments upward from group to group, while the speech tone also increments the first iteration of each group but then also varies or increments upward with each iteration within a single group. By one form, the difference in ultrasonic frequency from the carrier frequency tone to the speech tone is an audible frequency, and may be within the range of human speech. By one form, the varying or speech frequency is always larger than the fixed frequency. By one example, the varying frequency is an amplitude modulating (AM) frequency. By another form, and during the test procedures, AM-modulation is not used, and while two sine tones are present, it does not matter which tone is considered a carrier frequency (or no carrier frequency is even assumed). At a minimum, the two tones may have different ultrasound frequencies and the differential frequency is in an audible band. By one example form, the tones are emitted as an average difference over a range of ultrasonic frequencies, and by one form, may be an average difference value of ⅙ octave intervals over a range of ultrasonic frequencies in the groups mentioned above.

The IDP audible audio signal data may be induced by using at least one amplifier circuit in addition to the contributions of the diaphragm or other structure of the microphone and/or DUT microphone (or audio processing) subsystems themselves. This results in the intermodulation distortion product frequencies. In contrast, the ultrasonic audio signal data may be obtained directly from the ultrasonic audio signals captured by a reference microphone and in other words, without amplification and filtering to obtain sufficient reference ultrasonic audio signal data.

Process 400 may include “compare the audible audio signal data to ultrasonic audio signal data of the ultrasonic audio signals” 404. The comparing may involve generating a SPL of the audible audio signal data and that includes determining a second order IDP frequency of a difference between two ultrasonic frequencies of two tones of the ultrasonic audio signals. The second order IDP frequency then can be used to determine a SPL from spectrum data. Also, the comparing may include converting a sensitivity of the SPL of the IDP audio signal data to generate scaled SPL in a scale of the reference SPL of the ultrasonic audio signal data, and from a digital dBfs domain to an in-air dB20 μPa domain, for example, and for easier direct comparisons of SPL values. The result is a scaled pseudo or equivalent audible audio signal SPL of the second order IDP frequency.

The reference SPL of the ultrasonic audio signal data of the ultrasonic signals may be the same for both tones and may be close to the emitted SPL used at the stimuli device. The reference SPL may be determined by SPL spectrum analysis or other SPL analysis.

Thus, the scaled SPL of the audible or IDP audio signal data may be compared to the reference SPL of the ultrasonic audio signal data. This may be by straight subtraction or other desired computation resulting in a dB difference value.

Once the SPL is obtained for the audible or IDP audio signal data, process 400 may include “determine a plurality of susceptibility values each of a different ultrasonic frequency based on the comparing” 406, and “the plurality of susceptibility values represent an ultrasonic attack susceptibility of the audio device” 408. In the present example, the comparison comprises comparing SPL of the IDP audio signal data to SPL of the ultrasonic audio signal data so that the smaller the difference in SPL, the more likely an ultrasonic attack will be successful. This also may include generating the susceptibility value as a weighted average SPL difference between the ultrasonic audio signal data and the audible IDP audio signal data, and by one form, the weighting of the weighted average SPL difference emphasizes frequencies used by human speech.

The susceptibility value computation may be provided for each fixed or carrier signal frequency that is being analyzed. This provides a susceptibility level per ultrasonic frequency so that it can be understood which ultrasonic frequencies do or do not provide a raised susceptibility to ultrasonic attack for a specific audio device or audio device type as the DUT. Defenses to the attack then can be concentrated on those ultrasonic frequencies with raised susceptibilities rather than large ultrasonic frequency ranges.

Thus, it should be noted this is not a binary determination (of susceptible or not). Instead, process 400 may include “wherein the susceptibility value is of a range of available susceptibility values each indicating a probability of success of an ultrasonic attack on the audio device” 410. Thus, by one form, the range may be a range of 0 to −90 dB, and the higher the susceptibility value (or in other words, closer to zero), the more likely an ultrasonic attack will be successful at a particular indicated carrier frequency.

The processor circuitry also may be arranged to operate by comparing the susceptibility value to a susceptibility threshold, and by one example the threshold may be −30 dB. It has been found that when a susceptibility value is above −30 dB, the audio device (or DUT) has significant exposure to ultrasonic attack at the indicated ultrasonic frequency such that modifications to the audio device should be made to attempt to prevent such attacks. Such a threshold may change depending on many factors discussed below.

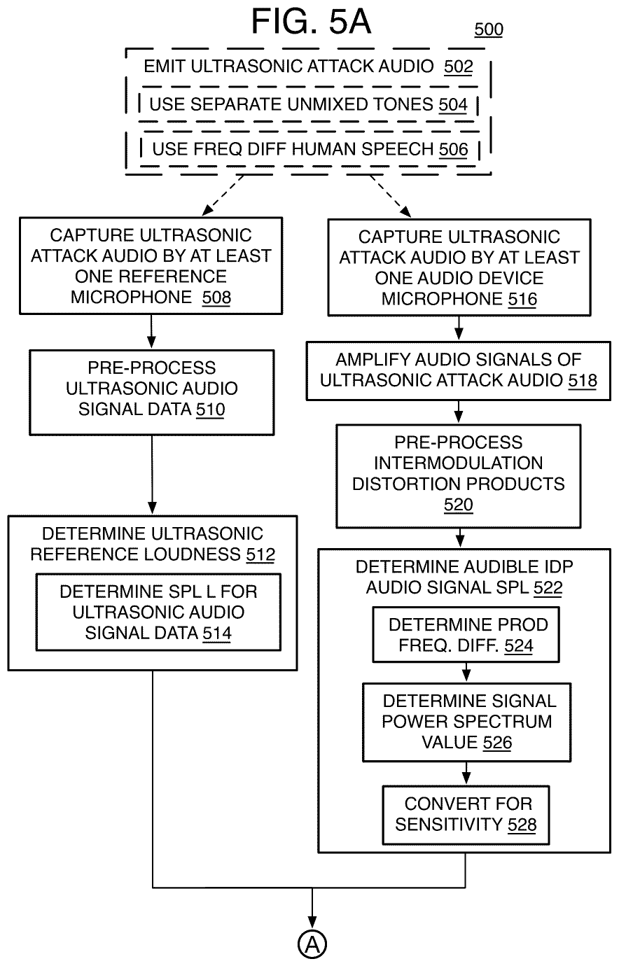

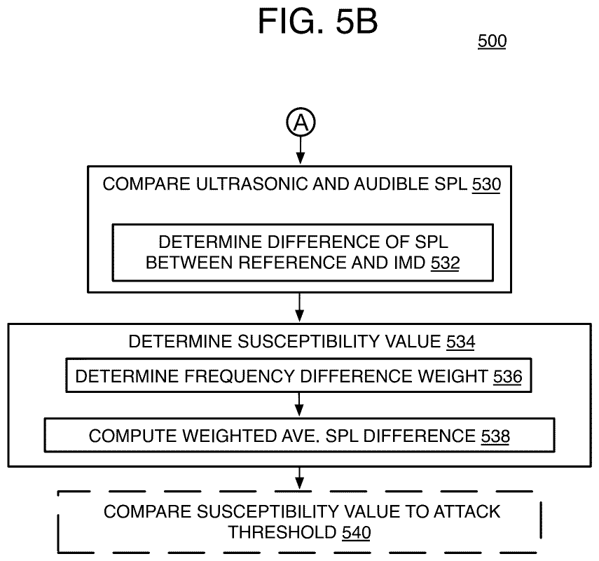

Referring to FIGS. 5A-5B for more detail, an example detailed process 500 to evaluate an audio device for ultrasonic attack susceptibility is provided. In the illustrated implementation, process 500 may include one or more operations, functions, or actions as illustrated by one or more of operations 502 to 540 at least generally numbered evenly. By way of non-limiting example, process 500 may be described herein with reference to example systems or system components 100, 200, 300, 1300, 1400, and 1500 of FIGS. 1-3 and 13-15, or any of the other systems, processes, or explanations described herein, and where relevant.

For the attacker device, process 500 may include “emit ultrasonic attack audio” 502, and this may include “use separate unmixed tones” 504, which may be emitted on separate loudspeakers. If the tones are emitted together on a single speaker, initial intermodulation distortion can occur due to the stimuli device (or test equipment), thereby emitting initial intermodulation distortion product audible audio and other IDP ultrasonic audio from the single speaker. The additional IDP frequency emissions will then be re-intermodulated at the DUT side to create multiple further IDP frequency distortions that cannot be easily compared to the initial ultrasonic signal data. Alternatively, the tones may be emitted on a single test loudspeaker as long as the loudspeaker and the testing (emitting) circuitry has low intermodulation distortions so that meaningful results can still be obtained from a DUT. In this case, distortions on test equipment must be at least an order of magnitude lower than distortions on the DUT. Other alternatives can be use of multiple frequencies at the same time (more than two tones). This can potentially accelerate the test time. The test setup can be split into any number of test loudspeakers or can be played on a single good quality loudspeaker. Thus, the emission of the tones is not otherwise limited as long as at least two tones can be emitted at the same time, and a resulting the IDP frequency results in within an audible range.

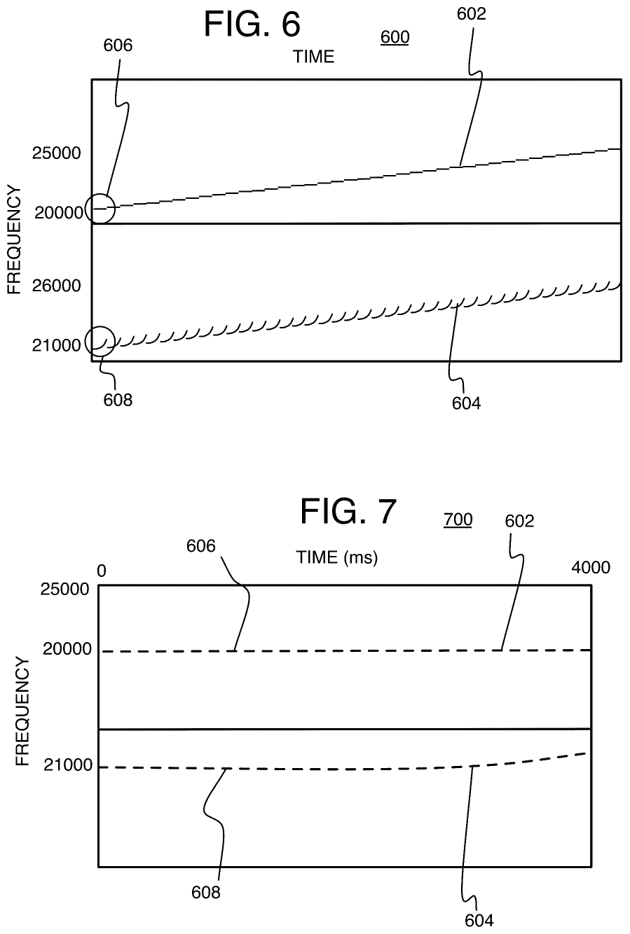

Referring to FIGS. 6-7, to enable reliable and repeatable testing procedures, a custom stereo testing sequence may be used. The total sequence 600 may have two steady or pure tones that last 100 ms, which is repeated a number of times, such as 1600 times in this example, and which may be referred to as sequence samples or iterations. By one form, 40 samples or iterations are grouped together in a single group to form 40 groups 606 or 608 in this example, and one group for each ultrasonic tone signal 602 and 604 at the same time. A single group time frame 700 is shown in FIG. 7. One ultrasonic signal U1 602 may be for a carrier signal and another signal U2 604 may be a varying speech signal which represents speech although it is merely a pure tone without embedded speech. As shown, the carrier signal frequency 602 is fixed within each individual carrier signal group 606 but is stepped upward from group to group 606. The varying signal 604 also has a stepped first frequency at each group 608, and then varies or increments the frequency upward within each group 608.

In other words, as shown on FIG. 7, the single time frame 700 has single groups 606 and 608 at the same time and has the two tones (or tone signals) 602 and 604 with one tone 602 fixed at a high frequency value fₐ in an ultrasonic range (in a first channel), and the other tone 604 at a varying frequency f_{b} in a second channel and greater than the fixed frequency fₐ. Thus, a signal with frequency fₐ can be interpreted as a carrier frequency during the ultrasonic attack, while a signal with frequency f_{b} can be interpreted as an AM-modulated speech component during the attack. Also, process 500 may include “use freq. diff. human speech” 506, which means use a frequency difference of human speech such that both frequencies are chosen in such a way that the difference of ultrasonic signal frequencies f_{b}-fₐ falls within an audible range, and by one specific example, within a range of about 200 Hz to 8 kHz which is, or is within or overlaps, a human speech frequency range. The tone frequencies then may be sampled as an average of ⅙ octave intervals for ultrasonic attack evaluation computations or averaged at other desired intervals. The carrier frequency fₐ is linearly distributed between the range of 20 kHz and 60 kHz to increment upward 1 kHz from group to group over the 40 groups. By one example form, the varying signal 604 starts at a first group 608 above 20 kHz, such as 21 kHz as one random example, and the first iteration of each subsequent group increments upward by a frequency of 1 kHz from group to group, and then increments upward by 1/40 kHz for each iteration within a single group 608. As mentioned in the alternative, the second (speech) tone also may be fixed when desired. The phase relationship between the two frequencies fₐ and f_{b} may be largely irrelevant. It also will be appreciated that the testing can be extended for near-ultrasound below 20 kHz, or extreme ultrasound above 60 kHz as desired.

With this arrangement then, no signal exists at audible frequencies present in the air. Instead by one example, only two stepped or sweep sine tones are used at ultrasonic frequencies, played back separately from the two loudspeakers, and to be blended at the receiving end. While the pure sine signals by themselves are not suitable to perform a successful voice command attack, they are quite adequate to measure and quantify the audio device or DUT susceptibility to such an attack.

During measurement, the two-channel test sequence is played through ultrasonic loudspeakers at the attacker device so that each loudspeaker emits a single tone at a same time. The test sequences may start with synchronization noises so both playback and recording do not need to be perfectly synchronized for evaluation analysis described herein.

Process 500 may include “capture ultrasonic attack audio by at least one reference microphone” 508. The reference microphone may be wired or wirelessly coupled, whether directly or indirectly, to a device that is to perform the ultrasonic attack evaluation processing as described above, and that may or may not be at the DUT device. By one form, the reference microphone may be one high quality microphone, such as a lab-grade measurement microphone or other microphone mentioned above, and there may be more than one reference microphone where the signals are combined into a single reference signal, although the signals could be analyzed separately to correspond one reference microphone to each DUT microphone as mentioned above. When wireless microphones are used, such a microphone may be coupled to the evaluation device via a wide area network (WAN), such as the internet, local area network (LAN), personal area network (PAN) such as a Bluetooth®, or other computer or communications network. By one form, such a network may be any typical office or residential WiFi network, such as a D2D (WiFi direct) network or any WiFi network. The incoming raw ultrasonic signal, such as the in the form of voltage levels, are captured by the microphone and may be recorded by placing it in a memory. At the same time, recordings on both DUT microphones and a reference microphone are made.

It will be appreciated that the reference microphone may be eliminated when a DUT is capable of recording ultrasonic signals, for example when the DUT supports sampling rates higher than 48 kHz. In this case, the DUT microphone analysis may be sufficient since both ultrasonic audio frequencies and the audible IDP frequencies will be present and can be analyzed as mentioned above, just as if the frequencies were captured on reference and DUT microphones.

Process 500 may include “pre-process ultrasonic audio signal data” 510. Thus, by one form, the ultrasonic audio signal may be at least digitized by an ADC. The reference microphone or a separate pre-processing unit may perform at least some local or internal pre-processing operations before being used for ultrasonic attack evaluation processing. Other optional pre-processing tasks may be performed such as high-pass filtering of the low-frequency noise (for example below 100 Hz), applying an EQ curve to compensate for microphone frequency response shape, or applying gains as desired. Otherwise, further pre-processing is not desired as mentioned above.

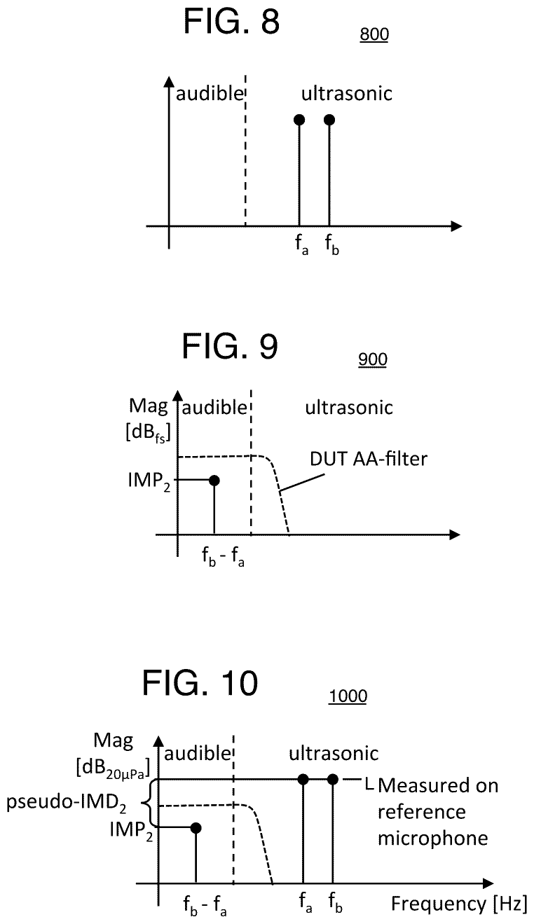

Referring to FIG. 8, process 500 may include “determine ultrasonic reference SPL” 512. The received ultrasonic audio signals may have ultrasonic frequencies fₐ and f_{b}, and may have the same or very similar magnitudes (which may be described as any of power, amplitude, or SPL) and in dBfs, by the example of graph 800.

Operation 512 may include “determine SPL L for ultrasonic audio signal data” 514. Specifically, the intermodulation distortion product is heavily dependent on the stimuli signal level. The stimuli SPL ideally should be the same as the reference ultrasonic audio signal SPL as captured by the reference microphone. To make the procedure repeatable and reliable, an ultrasonic stimuli level at the stimuli (or attacker) device can be preset relatively high and the same for the SPL measurements performed herein. During experiments, it was found that the following stimuli (or stimuli ultrasonic audio signal data SPL) was adequate:

$$L = {S}_{Ref} ( {f}_{a} ) = {S}_{Ref} ( {f}_{b} ) = 70 {dB}_{20 μ Pa} \qquad ( 1 )$$

Such stimuli SPL level was found to be sufficient to perform reliable tests and feasible to reproduce using already commercially available hardware. At the reference device or microphone, spectrogram or other SPL analysis may be used to determine the actual reference SPL L of the stimuli ultrasonic signals received at the reference microphone. In reality, it is impossible or impractical to get an SPL exactly at 70 dB_{20μPa} as emitted for each single sine tone frequency. The actual measured values were to be around 70 dB20μ Pa+/−several dB depending on the quality of the test loudspeakers and quality of the test room.

Process 500 next may include “capture ultrasonic attack audio by at least one audio device microphone” 516, and as described above with one or more DUT microphones 110. The emitted ultrasonic audio signals received by the DUT are provided for typical pre-processing on that DUT device.

Thus, process 500 may include “amplify audio signals of ultrasonic attack audio” 518, and as explained above, where the non-linearities of the amplifier alone or with those of the microphone components generate second order intermodulation distortion products (IDPs). The IDPs also may be referred to as pseudo or equivalent audible audio signal frequencies. Particularly, this generates an audible frequency spike within an audible range that is a subtraction of the ultrasonic audio signal frequencies f_{b}-fₐ as described above.

Referring to FIG. 9, process 500 may include “pre-process intermodulation distortion products” 520, and this may include low-pass filtering or anti-aliasing that drops the ultrasonic signals but keeps the audible IDP frequency spike as shown on graph 900. The magnitude or SPL of the audible frequency spike (or audible IDP audio signal data) is referred to as 2^{nd} intermodulation product (IMP₂) level, where subscript 2 refers to the second order of the IDPs. Otherwise, any other pre-processing may be performed as mentioned above with reference pre-processing operation 510 as long as it does not interfere with computations described herein. Particularly, if the pre-processing is non-destructive (for example, does not alter the SPL level) to IDP signals (the tone signals or sine tone signals), then such processing may be performed when desired. In general, acoustic echo cancellation (AEC) may be non-destructive. Otherwise, automatic gain control (AGC) or denoising can alter the level of the since tone signals, or in a worst case, such pre-processing can even remove the signals completely which will invalidate the susceptibility results using the disclosed methods. It also will be appreciated that the amplification mentioned above, in addition to at least the filtering, may or may not be considered as part of pre-processing as well.

Process 500 may include “determine audible IDP audio signal SPL” 522, and refers to the pseudo or equivalent audible signals. This also may be referred to as a baseband intermodulation distortion product level calculation or calculation of IMP₂. This operation involves first “determine product frequency difference” 524, and particular to obtain the audible IDP audio signal frequency or here a differential frequency f_{b}-fₐ. The differential frequencies then may be used just in time or stored for later use.

Process 500 may include “determine signal power spectrum value” 526. In detail, the 2^{nd} intermodulation distortion product level (IMP₂) can be measured by determining the level of the differential frequency at a differential frequency f_{b}-fₐ of the DUT recording.

$${IMP}_{2} ( {f}_{a} , {f}_{b} ) = {S}_{DUT} ( {f}_{b} - {f}_{a} ) [ dB fs ] \qquad ( 2 )$$

where fₐ and f_{b} are as described above, S_{DUT} is a signal power spectrum value of the DUT recording when only a part of a signal such as the two ultrasonic tones of interest are present in the air, no signal is available in-air in an audible band, but intermodulation products are induced on DUT microphones. The units here are in dBfs (such as with a maximum of 0 to −90 dBfs).

Process 500 then may include “convert for sensitivity” 528. By incorporating a microphone sensitivity value of the DUT, an in-air equivalent sound pressure level of 2^{nd} order intermodulation distortion product can be calculated in the same scale as the reference ultrasonic audio signal data as follows.

$${IMP}_{2} [ {dB}_{20 μ Pa} ] = {IMP}_{2} [ dB fs ] - Sensitivity [ \frac{dB fs}{20 μPa} ] \qquad ( 3 )$$

In other words, sensitivity is applied to convert values from digital domains (dBfs) from both DUT and reference microphones, to in-air sound pressure domain (db20 uPa) since the dBfs scale on the DUT can be much different than dBfs scale on a reference microphone, as their sensitivities, such as distances from the source for example, and thus maximum levels are different. When the SPL levels are converted to dB_{20μPa}, which is an absolute scale, the reference and DUT levels can be compared directly. The resulting audible audio signal SPL IMP₂ is the physical interpretation of how loud would an equivalent in-air sound be, resulting in the same digital signal (SPL) level as the intermodulation distortion product of a specific ultrasonic signal pair.

Process 500 may include “compare ultrasonic and audible SPL” 530, or in other words, compare the audible IDP audio signal data SPL IMP₂ to the ultrasonic audio signal data SPL L. Thus, this operation may include “determine difference of SPL between reference and IMD” 532. By one example form then, the audible SPL IMP₂ may be used in a ratio or difference with the ultrasonic SPL L. This computation of the ratio or difference between stimuli level and intermodulation product also may be a more accurate practice than calculating and using IMP₂ alone since this ratio or difference will be less affected by inaccuracies in a reproduced or actual preset stimuli playback level of ultrasonic tones than the inaccuracies from the computed IMP₂.

The ratio (or difference) between stimuli level and 2^{nd} order distortion products may be referred to as 2^{nd} order intermodulation distortion (IMD₂) or pseudo IMD₂. As mentioned above, in the proposed measurement pipeline, no single extraction point exists where both ultrasonic stimuli tones and distortion products are present in the same audio signal data. Intermodulation products are only found inside the recording from the DUT, while ultrasonic stimuli signals are only found on the recording from the reference microphone. A DUT recording does not contain stimuli signals since their frequency is higher than DUT microphone upper cutoff frequency, and the reference microphone does not contain distortion product of the DUT. As mentioned above, the term ‘pseudo’ is used here because the stimuli signals (ultrasonic) are not captured on the same device as direct audible signals since they are ultrasonic, and only the IMD products signals or spikes are generated on the DUT device.

In order to compute the SPL difference IMD₂, the calculated in-air equivalent SPL IMP₂ and the reference microphone in-air level L of the ultrasonic stimulus may be used as follows to calculate the difference between those SPL values within the sound pressure level domain.

$${pseudoIMD}_{2} [ dB ] = {IMP}_{2} [ {dB}_{20 μ Pa} ] - L [ {dB}_{20 μ Pa} ] \qquad ( 4 )$$

These operations may be repeated for each pair of frequencies fₐ and f_{b}. Referring to FIG. 10, equation (4) is shown graphically and shows the SPL or magnitude difference pseudo IMD₂ measured from both the ultrasonic and pseudo audible frequencies.

Once the psuedoIMD₂ (or just IMD₂) values for each possible ultrasonic frequency pair is computed, by one form, the IMD₂ values may be used as initial rough susceptibility values. For easier interpretation, however, the IMD₂ values may be averaged and weighted. In one example, process 500 may include “determine susceptibility value” 534 by using equation (5) below to compute a susceptibility value Su as follows:

$$Su = susceptibility ( {f}_{a} ) [ dB ] = \frac{1}{N} {\sum }_{{{f}_{b} = {f}_{bmin}}^{}}^{{f}_{bmax}} {IMD}_{2} ( {f}_{a} , {f}_{b} ) [ dB ] + A ( {f}_{b} - {f}_{a} ) [ dB ] \qquad ( 5 )$$

where f_{bmin}/f_{bmax} is lowest/highest f_{b} frequency used with measurements in conjunction with a specific frequency fₐ, N is a number of measured datapoints with specific frequency fₐ, (or in other words, an fₐ and f_{b} combination) and A( ) is a weighting factor or coefficient.

Thus, process 500 may include “determine frequency difference weight” 536. In this example, A(f) is the gain of an A-weighting function at frequency f. A-weighting coefficient values may be extracted from a standard IEC A-weighting curve using the differential frequency f_{b}−fₐ.

Process 500 next may include “compute weighted average SPL difference” 538. This will result in a total of N² possible combinations of each fₐ and f_{b} when the number of selected fₐ and f_{b} frequencies is equal to N. Here, the weighted SPL difference of each combinations for a particular frequency fₐ is then averaged for each individual fₐ to compute a single weighted average susceptibility value for each carrier frequency fₐ.

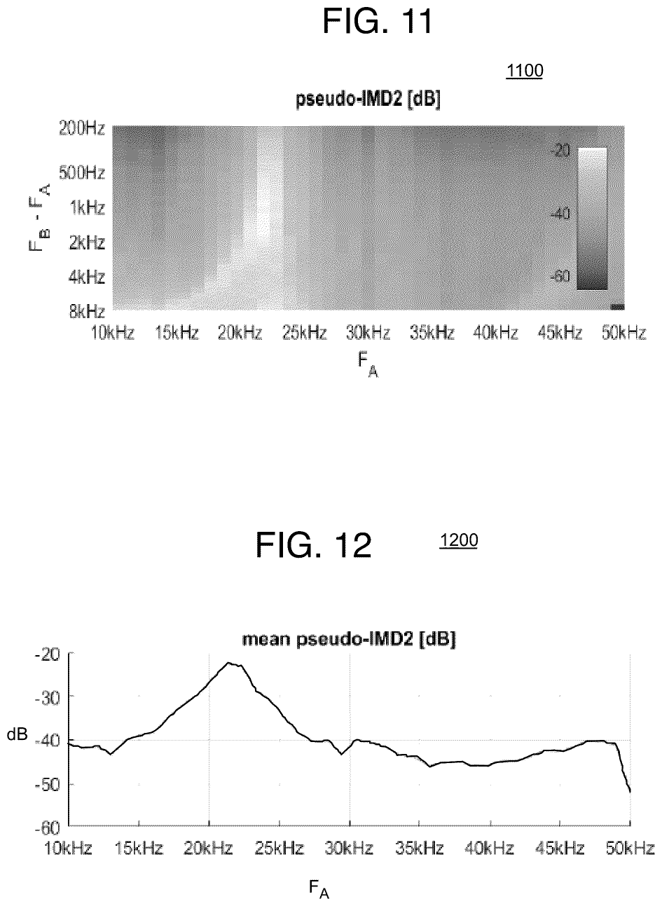

Referring to FIG. 11, and after performing these calculations, the weighted susceptibility values (before averaging) can be mapped as an array of 2D results on a power spectrum 1100 where the vertical axis is the differential frequency (f_{b}-fₐ) of each combination and the horizontal axis is the carrier frequency fₐ. The colors on the graph indicate a weighted level of SPL difference or weighted pseudo-IMD2 [dB].

Referring to FIG. 12, and to simplify the interpretation of the resulting weighted susceptibility values of the spectrogram 1100, the spectrogram data is converted into a graph 1200 where the multiple weighted susceptibility values of each carrier frequency has been averaged into a single susceptibility value per carrier frequency (or mean (weighted) pseudo-IMD2 [dB]). By one example form, the process 500 assumes that fₐ is always the carrier frequency, and the final susceptibility metric for a specific frequency fₐ is a weighted average of IMD₂ originating from a stimuli of specific carrier frequency fₐ and all measured frequencies f_{b}.

Process 500 may include “compare susceptibility value to attack threshold” 540. The higher the resulting susceptibility metric (or negative SPL value) is, the smaller the difference between the audible IDP audio signal data and the reference ultrasonic audio signal data, and therefore, the easier it is to perform a successful ultrasonic attack at the given ultrasonic carrier frequency. It has been found that a susceptibility value above a threshold of −30 dB should be considered a high susceptibility that warrants defensive actions. Susceptibility values below −60 dB could be consider safe since the resulting intermodulation product will likely be masked by the microphone's inherent self-noise during a real attack attempt. Such a susceptibility threshold may depend on many factors such as the microphone's noise levels, noise gate threshold level, and/or a voice activity detector (VAD) activation threshold level which relates to the estimated or actual SPL needed for an ASR application to be able to understand commands in the audio. For example, if a resulting susceptibility is below the susceptibility threshold, and the susceptibility threshold is set to a level which corresponds to end-product SPLs for a given playback SPL that is below a VAD activation threshold, then setting the susceptibility threshold may be equivalent to performing hundreds of hours of ultrasonic attack speech recognition testing to detect the ultrasonic attacks.

Referring to FIGS. 11-12, graphs 1100 and 1200 also reflect actual experimental results. A DUT was evaluated using a reference microphone to perform the proposed method. The graphs 1100 and 1200 show a high susceptibility at about 21-22 kHz ultrasonic carrier signal. The DUT was then tested specifically against ultrasonic attack using a carrier frequency of 21 kHz and 35 kHz. Attacks at 21 kHz had a significant success rate even at a distance of 2 m, while attacks at 35 kHz were almost impossible unless the distance between the DUT and the attacker equipment was very small (below 50 cm). The ultrasonic attacks were reproduced at high sound pressure levels (SPLs) such as 80 dB_{20μPa} from 2 m away from the DUT and reference microphones, and up to 120 dB_{20μPa} from 0.5 m away.

While implementation of the example processes 400 and 500 as well as systems, devices, components, or explanations 100, 200, 300, 600, 700, 800, 900, and 1000 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality. Other than the term “logic unit”, the term “unit” refers to any one or combination of software logic, firmware logic, hardware logic, and/or circuitry configured to provide the functionality described herein.

As used in any implementation described herein, the term “component” may refer to a module, unit, or logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, and processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

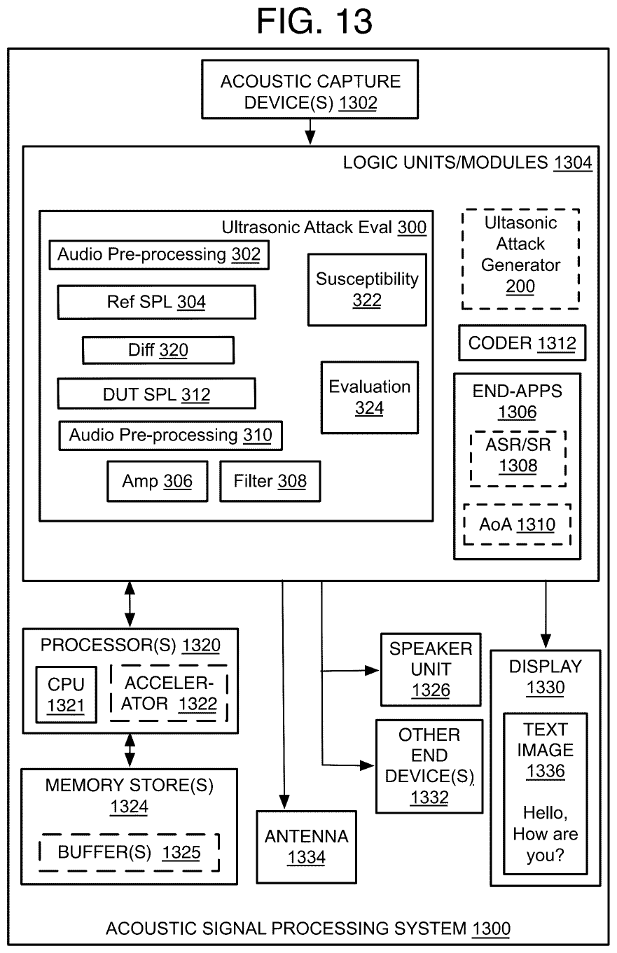

Referring to FIG. 13, an example acoustic signal processing system 1300 is arranged to provide ultrasonic attack evaluation in accordance with at least some implementations of the present disclosure. In various implementations, the example acoustic signal processing system 1300 may have at least one or both acoustic capture devices 1302, such as listening or source devices described herein, and has one or more microphones to receive acoustic waves and form acoustical signal data. This can be implemented in various ways. Thus, in one form, the acoustic signal processing system 1300 is one of the listening devices, or is on a device, with one or more microphones, such as the DUT with microphones or reference microphone described above. In other examples, the acoustic signal processing system 1300 may be in communication with at least the reference microphone and the DUT device. The system 1300 may be remote from these acoustic signal capture devices 1302 such that logic modules 1304 may communicate remotely with, or otherwise may be communicatively coupled to, the microphones for further processing of the acoustic data. In this case, the logic modules 1304 may be part of, or on, a server or cloud device or other remote device.

In any of these cases, such technology may include a smart phone, smart speaker, a tablet, laptop or other computer, video or phone conference console, dictation machine, other sound recording machine, a mobile device or an on-board device, IoT device, home or building system device, security system device, or any combination of these, or other such devices. Thus, in one form, audio capture devices 1302 may include audio capture hardware including one or more sensors as well as actuator controls. These controls may be part of a sensor module or component for operating the sensor. The sensor component may be part of the audio capture device 1302, or may be part of the logical modules 1304 or both. Such sensor component can be used to convert sound waves into an electrical acoustic signal. The audio capture device 1302 also may have an A/D converter, AEC unit, amplifier, other filters, and so forth to provide a digital signal for acoustic signal processing as described above.

In the illustrated example, when the system 1300 is or has a stimuli or ultrasonic attack device, the logic units and modules 1304 may include the ultrasonic attack generator 200 to emit ultrasonic audio signals as described above. In addition, or instead, the system 1300 may include the ultrasonic attack evaluation unit 300 that may have an ultrasonic audio pre-processing unit 302, reference SPL unit 304, amplifier 306, filter unit 308, audible audio pre-processing unit 310, DUT SPL unit 312, a differencing unit 320, a susceptibility unit 322, and an evaluation unit 324.

For transmission and emission of the audio, the system 1300 may have a coder unit 1312 for encoding and an antenna 1334 for transmission to a remote output device, as well as a speaker 1326 for local emission.

The logic modules 1304 also may include an end-apps unit 1306 to perform further audio processing such as with an ASR/SR unit 1308, an angle of arrival (AoA) unit 1310 (or a beam-forming unit), and/or other end applications that may be provided to analyze and otherwise use the audio signals with best or better audio quality scores. The logic modules 1304 also may include other end devices 1332, which may include a decoder to decode input signals when audio is received via transmission, and if not already provided with coder unit 1312. These units may be used to perform the operations described above where relevant. The tasks performed by these units or components are indicated by their labels and may perform similar tasks as those units with similar labels as described above.

The acoustic signal processing system 1300 may have processor circuitry 1320 forming one or more processors which may include central processing unit (CPU) 1321 and/or one or more dedicated accelerators 1322 such as the Intel Atom, memory stores 1324 with one or more buffers 1325 to hold audio-related data such as audio signal data and any ultrasonic attack evaluation related data described above, at least one speaker unit 1326 to emit audio based on the input audio signals, or responses thereto, and may be ultrasonic speakers described above and, when desired, one or more displays 1330 to provide images 1336 of text for example as a visual response to acoustic signals. The other end device(s) 1332 also may perform actions in response to the acoustic signal. In one example implementation, the acoustic signal processing system 1300 may have the at least one processor of the processor circuitry 1320 communicatively coupled to the acoustic capture device(s) 1302 (such as at least two microphones of one or more listening devices) and at least one memory 1324. As illustrated, any of these components may be capable of communication with one another and/or communication with portions of logic modules 1304 and/or audio capture device 1302. Thus, processors of processor circuitry 1320 may be communicatively coupled to the audio capture device 1302, the logic modules 1304, and the memory 1324 for operating those components.

While typically the label of the units or blocks on device 1300 at least indicates which functions are performed by that unit, a unit may perform additional functions or a mix of functions that are not all suggested by the unit label. Also, although acoustic signal processing system 1300, as shown in FIG. 13, may include one particular set of units or actions associated with particular components or modules, these units or actions may be associated with different components or modules than the particular component or module illustrated here.

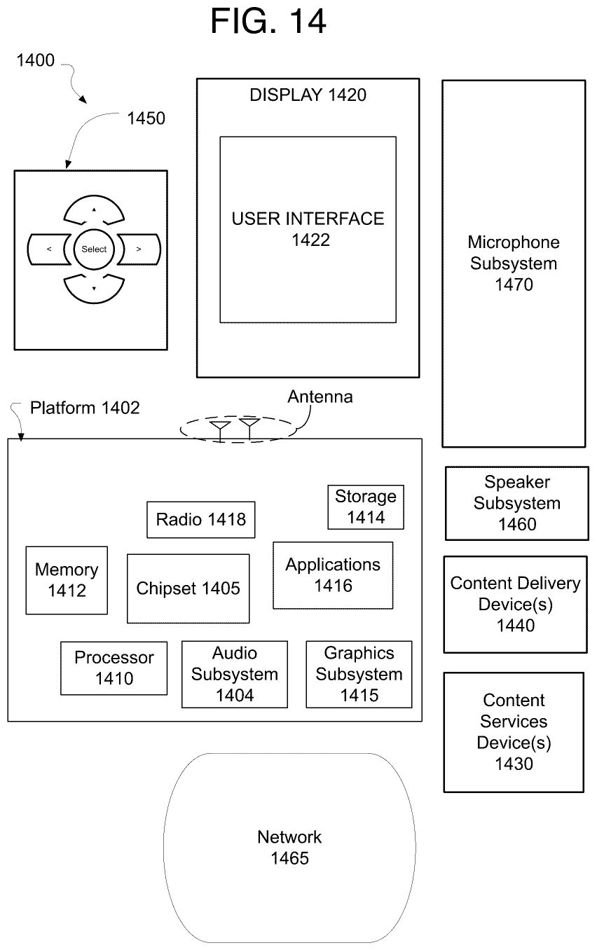

Referring to FIG. 14, an example system 1400 in accordance with the present disclosure operates one or more aspects of the audio processing system described herein including that of system 1300 (FIG. 13). It will be understood from the nature of the system components described below that such components may be associated with, or used to operate, certain part or parts of the audio processing system described above. In various implementations, system 1400 may be a media system although system 1400 is not limited to this context. For example, system 1400 may be incorporated into, or have, one or more microphones on one or more listening devices or may be at least partly on devices without microphones, whether on a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any computing device, including servers, and so forth, to perform any of the functions related to ultrasonic attack susceptibility analysis described above.

In various implementations, system 1400 includes a platform 1402 coupled to a display 1420. Platform 1402 may receive content from a content device such as content services device(s) 1430 or content delivery device(s) 1440 or other similar content sources. A navigation controller 1450 including one or more navigation features may be used to interact with, for example, platform 1402, speaker subsystem 1460, microphone subsystem 1470, and/or display 1420. Each of these components is described in greater detail below.

In various implementations, platform 1402 may include any combination of a chipset 1405, processor 1410, memory 1412, storage 1414, audio subsystem 1404, graphics subsystem 1415, applications 1416 and/or radio 1418. Chipset 1405 may provide intercommunication among processor 1410, memory 1412, storage 1414, audio subsystem 1404, graphics subsystem 1415, applications 1416 and/or radio 1418. For example, chipset 1405 may include a storage adapter (not depicted) capable of providing intercommunication with storage 1414. Either audio subsystem 1404 or the microphone subsystem 1470 may have the microphone type (or target model) selection unit described herein. Otherwise, the system 1400 may be or have one of the listening devices.

Processor 1410 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1410 may be dual-core processor(s), dual-core mobile processor(s), and so forth.

Memory 1412 may be implemented as a volatile memory device such as, but not limited to, a Random Access Memory (RAM), Dynamic Random Access Memory (DRAM), or Static RAM (SRAM).

Storage 1414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1414 may include technology to increase the storage performance enhanced protection for valuable digital media when multiple hard drives are included, for example.

Audio subsystem 1404 may perform processing of audio such as acoustic signals for one or more audio-based applications such as audio signal enhancement, ultrasonic attack evaluation as described herein, speech recognition, speaker recognition, and so forth. The audio subsystem 1404 may comprise one or more processing units, memories, and accelerators. Such an audio subsystem may be integrated into processor 1410 or chipset 1405. In some implementations, the audio subsystem 1404 may be a stand-alone card communicatively coupled to chipset 1405. An interface may be used to communicatively couple the audio subsystem 1404 to a speaker subsystem 1460, microphone subsystem 1470, and/or display 1420.

Graphics subsystem 1415 may perform processing of images such as still or video for display. Graphics subsystem 1415 may be a graphics processing unit (GPU) or a visual processing unit (VPU), for example. An analog or digital interface may be used to communicatively couple graphics subsystem 1415 and display 1420. For example, the interface may be any of a High-Definition Multimedia Interface, Display Port, wireless HDMI, and/or wireless HD compliant techniques. Graphics subsystem 1415 may be integrated into processor 1410 or chipset 1405. In some implementations, graphics subsystem 1415 may be a stand-alone card communicatively coupled to chipset 1405. It should be noted that the graphics subsystem, such as accelerators, also may be used for audio processing.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further embodiments, the functions may be implemented in a consumer electronics device.

Radio 1418 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1418 may operate in accordance with one or more applicable standards in any version.

In various implementations, display 1420 may include any television type monitor or display. Display 1420 may include, for example, a computer display screen, touch screen display, video monitor, television-like device, and/or a television. Display 1420 may be digital and/or analog. In various implementations, display 1420 may be a holographic display. Also, display 1420 may be a transparent surface that may receive a visual projection. Such projections may convey various forms of information, images, and/or objects. For example, such projections may be a visual overlay for a mobile augmented reality (MAR) application. Under the control of one or more software applications 1416, platform 1402 may display user interface 1422 on display 1420.

In various implementations, content services device(s) 1430 may be hosted by any national, international and/or independent service and thus accessible to platform 1402 via the Internet, for example. Content services device(s) 1430 may be coupled to platform 1402 and/or to display 1420, speaker subsystem 1460, and microphone subsystem 1470. Platform 1402 and/or content services device(s) 1430 may be coupled to a network 1465 to communicate (e.g., send and/or receive) media information to and from network 1465. Content delivery device(s) 1440 also may be coupled to platform 1402, speaker subsystem 1460, microphone subsystem 1470, and/or to display 1420.

In various implementations, content services device(s) 1430 may include a network of microphones, a cable television box, personal computer, network, telephone, Internet enabled devices or appliance capable of delivering digital information and/or content, and any other similar device capable of unidirectionally or bidirectionally communicating content between content providers and platform 1402 and speaker subsystem 1460, microphone subsystem 1470, and/or display 1420, via network 1465 or directly. It will be appreciated that the content may be communicated unidirectionally and/or bidirectionally to and from any one of the components in system 1400 and a content provider via network 1465. Examples of content may include any media information including, for example, video, music, medical and gaming information, and so forth.

Content services device(s) 1430 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1402 may receive control signals from navigation controller 1450 having one or more navigation features. The navigation features of controller 1450 may be used to interact with user interface 1422, for example. In embodiments, navigation controller 1450 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1404 also may be used to control the motion of articles or selection of commands on the interface 1422.

Movements of the navigation features of controller 1450 may be replicated on a display (e.g., display 1420) by movements of a pointer, cursor, focus ring, or other visual indicators displayed on the display or by audio commands. For example, under the control of software applications 1416, the navigation features located on navigation controller 1450 may be mapped to virtual navigation features displayed on user interface 1422, for example. In embodiments, controller 1450 may not be a separate component but may be integrated into platform 1402, speaker subsystem 1460, microphone subsystem 1470, and/or display 1420. The present disclosure, however, is not limited to the elements or in the context shown or described herein.

In various implementations, drivers (not shown) may include technology to enable users to instantly turn on and off platform 1402 like a television with the touch of a button after initial boot-up, when enabled, for example, or by auditory command. Program logic may allow platform 1402 to stream content to media adaptors or other content services device(s) 1430 or content delivery device(s) 1440 even when the platform is turned “off.” In addition, chipset 1405 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 1400 may be integrated. For example, platform 1402 and content services device(s) 1430 may be integrated, or platform 1402 and content delivery device(s) 1440 may be integrated, or platform 1402, content services device(s) 1430, and content delivery device(s) 1440 may be integrated, for example. In various embodiments, platform 1402, audio subsystem 1404, speaker subsystem 1460, and/or microphone subsystem 1470 may be an integrated unit. Display 1420, speaker subsystem 1460, and/or microphone subsystem 1470 and content service device(s) 1430 may be integrated, or display 1420, speaker subsystem 1460, and/or microphone subsystem 1470 and content delivery device(s) 1440 may be integrated, for example. These examples are not meant to limit the present disclosure.

In various implementations, system 1400 may be implemented as a wireless system, a wired system, or a combination of both. When implemented as a wireless system, system 1400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1402 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, text message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 14.

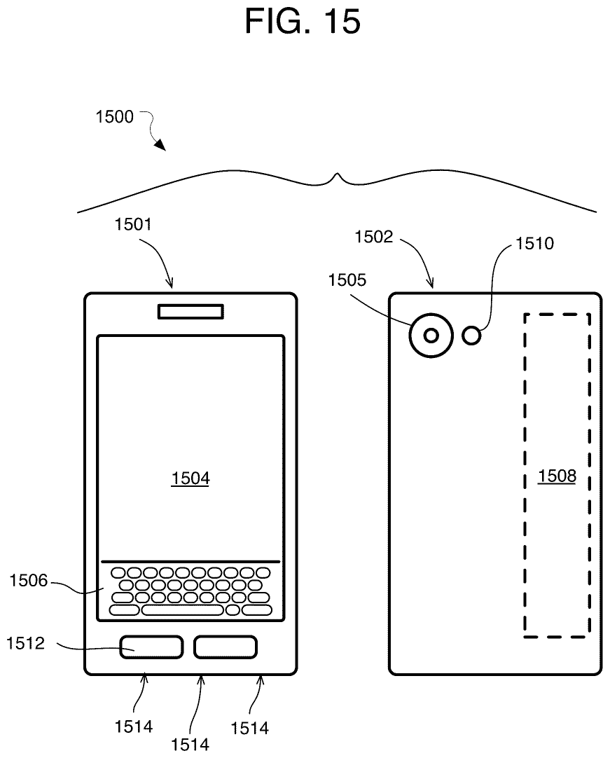

Referring to FIG. 15, a small form factor device 1500 is one example of the varying physical styles or form factors in which systems 1300 or 1400 may be embodied. By this approach, device 1500 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart speaker, or smart television), mobile internet device (MID), messaging device, data communication device, phone conference console, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 15, device 1500 may include a housing with a front 1501 and a back 1502. Device 1500 includes a display 1504, an input/output (I/O) device 1506, and an integrated antenna 1508. Device 1500 also may include navigation features 1512. I/O device 1506 may include any suitable I/O device for entering information into a mobile computing device. Examples for I/O device 1506 may include an alphanumeric keyboard, a numeric keypad, a touch pad, input keys, buttons, switches, speakers, voice recognition device and software, and so forth. Information also may be entered into device 1500 by way of one or more microphones 1514. By one example alternative, microphones 1514 may be placed on the bottom of the smart phone as shown, in addition to two more microphones at the front and back near the top of the device 1500. As shown, device 1500 may include a camera 1505 (e.g., including a lens, an aperture, and an imaging sensor) and a flash 1510 integrated into back 1502, front 1501, or elsewhere of device 1500.

Various implementations may be implemented using hardware elements, software elements, or a combination of both. Examples of hardware elements may include processor circuitry forming processors and/or microprocessors, as well as circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a computer-implemented method of audio processing comprises receiving, by processor circuitry, audible audio signal data of intermodulation distortion products (IDPs) based on ultrasonic audio signals received by at least one microphone of an audio device; comparing the audible audio signal data to ultrasonic audio signal data of the ultrasonic audio signals; and determining an ultrasonic attack susceptibility of the audio device depending on the comparing, and comprising determining a plurality of susceptibility values each of a different ultrasonic frequency.

In example 2, the subject matter of example 1, wherein the susceptibility value is of a range of available susceptibility values each indicating a probability of success of an ultrasonic attack on the audio device.

In example 3, the subject matter of example 1 or 2, wherein the IDP audio signal data is generated by using at least one amplifier that generates intermodulation distortion products at frequencies in the human hearing range, and wherein the ultrasonic audio signal data is obtained directly from the ultrasonic audio signals.

In example 4, the subject matter of any one of examples 1 to 3, wherein the ultrasonic audio signal comprises two ultrasonic tones.

In example 5, the subject matter of example 4, wherein the two ultrasonic tones are emitted simultaneously from separate speakers.

In example 6, the subject matter of example 4 or 5, wherein the two ultrasonic tones have a total duration divided into groups, wherein each group has one of the two ultrasonic tones maintained at a fixed frequency that changes from group to group, and the other of the two ultrasonic tones to have a varying frequency within an individual group.

In example 7, the subject matter of example 4 or 5, wherein the two ultrasonic tones are both fixed at a different frequency.

In example 8, the subject matter of any one of examples 4 to 7, wherein a difference of the frequencies of the two ultrasonic tones emitted at a same time is within an audible frequency range.

In example 9, the subject matter of any one of examples 4 to 8, wherein a difference of the frequencies of the two ultrasonic tones is within a frequency range of human speech.

In example 10, the subject matter of any one of examples 1 to 9, wherein the comparing comprises generating a sound pressure level (SPL) of the audible audio signal data comprising determining a second order IDP frequency of a difference between two ultrasonic frequencies of two tones of the ultrasonic audio signals, and using the second order IDP frequency to determine a SPL from spectrum data.

In example 11, the subject matter of example 10, wherein the determining comprises generating a susceptibility metric that is associated with the difference of the SPL of the audible audio signal data and an SPL of the ultrasonic signals, wherein the probability of a successful ultrasonic attack at a particular one of the ultrasonic frequencies is indicated by the value of the metric.

In example 12, a computer-implemented system comprises memory to hold data associated with audio signals; and processor circuitry communicatively connected to the memory, the processor circuitry to operate by: receiving, by processor circuitry, intermodulation distortion product (IDP) audio signal data based on ultrasonic audio signals received by at least one microphone of an audio device; and comparing the IDP audio signal data to ultrasonic audio signal data based on the ultrasonic audio signals; and determining a plurality of susceptibility values of a range of available susceptibility values and depending on the comparing, wherein individual ones of the plurality of susceptibility values indicate a probability a different ultrasonic frequency can cause a successful ultrasonic attack.

In example 13, the subject matter of example 12, wherein the susceptibility value is a weighted average sound pressure level (SPL) difference between the ultrasonic audio signal data and the audible IDP audio signal data.

In example 14, the subject matter of example 13, wherein weighting of the weighted average SPL difference emphasizes frequencies used by human speech.

In example 15, the subject matter of any one of examples 12 to 14, wherein the ultrasonic audio signals comprises two pure ultrasonic tones with a difference in frequency in an audible frequency band.

In example 16, the subject matter of any one of examples 12 to 15, wherein the processor circuitry is arranged to operate by comparing the susceptibility value to a threshold.

In example 17, at least one non-transitory computer readable medium comprising a plurality of instructions that in response to being executed on a computing device, causes the computing device to operate by: receiving, by processor circuitry, intermodulation distortion product (IDP) audio signal data based on ultrasonic audio signals received by at least one microphone of an audio device; and comparing the IDP audio signal data to ultrasonic audio signal data based on the ultrasonic audio signals; and determining an ultrasonic attack susceptibility of the audio device depending on the comparing, and comprising determining a plurality of susceptibility values of a range of available susceptibility values, wherein individual ones of the plurality of susceptibility values indicate a probability a different ultrasonic frequency can cause a successful ultrasonic attack.

In example 18, the subject matter of example 17, wherein the comparing comprises converting a sensitivity of the sound pressure level (SPL) of the IDP audio signal data to generate scaled SPL in a scale of a reference SPL of the ultrasonic audio signal data, and comparing the scaled SPL of the IDP audio signal data to the reference SPL of the ultrasonic audio signal data.

In example 19, the subject matter of example 17, wherein the comparing comprises comparing SPL of the IDP audio signal data to SPL of the ultrasonic audio signal data, wherein the smaller the difference in SPL, the more likely an ultrasonic attack will be successful.

In example 20, the subject matter of example 17, wherein the instructions are arranged to cause the computing device to operate by comparing the susceptibility values to a threshold of −30 dB.

In example 21, a device or system includes a memory and a processor to perform a method according to any one of the above implementations.

In example 22, at least one machine readable medium includes a plurality of instructions that in response to being executed on a computing device, cause the computing device to perform a method according to any one of the above implementations.

In example 23, an apparatus may include means for performing a method according to any one of the above implementations.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of audio processing, comprising:
receiving, by processor circuitry, audible audio signal data of intermodulation distortion products (IDPs) based on ultrasonic audio signals received by at least one microphone of an audio device;
comparing the audible audio signal data to ultrasonic audio signal data of the ultrasonic audio signals; and
determining a plurality of susceptibility values each of a different ultrasonic frequency based on the comparing, wherein the plurality of susceptibility values represent an ultrasonic attack susceptibility of the audio device.

2. The method of claim 1, wherein the susceptibility value is of a range of available susceptibility values each indicating a probability of success of an ultrasonic attack on the audio device.

3. The method of claim 1, wherein the IDP audio signal data is generated by using at least one amplifier that generates intermodulation distortion products at frequencies in the human hearing range, and wherein the ultrasonic audio signal data is obtained directly from the ultrasonic audio signals.

4. The method of claim 1, wherein the ultrasonic audio signal comprises two ultrasonic tones.

5. The method of claim 4, wherein the two ultrasonic tones are emitted simultaneously from separate speakers.

6. The method of claim 4, wherein the two ultrasonic tones have a total duration divided into groups, wherein each group has one of the two ultrasonic tones maintained at a fixed frequency that changes from group to group, and the other of the two ultrasonic tones to have a varying frequency within an individual group.

7. The method of claim 4, wherein the two ultrasonic tones are both fixed at a different frequency.

8. The method of claim 4, wherein a difference of the frequencies of the two ultrasonic tones emitted at a same time is within an audible frequency range.

9. The method of claim 4, wherein a difference of the frequencies of the two ultrasonic tones is within a frequency range of human speech.

10. The method of claim 1, wherein the comparing comprises generating a sound pressure level (SPL) of the audible audio signal data comprising determining a second order IDP frequency of a difference between two ultrasonic frequencies of two tones of the ultrasonic audio signals, and using the second order IDP frequency to determine a SPL from spectrum data.

11. The method of claim 10, wherein the determining comprises generating a susceptibility metric that is associated with the difference of the SPL of the audible audio signal data and an SPL of the ultrasonic signals, wherein the probability of a successful ultrasonic attack at a particular one of the ultrasonic frequencies is indicated by the value of the metric.

12. A computer-implemented system, comprising:
memory to hold data associated with audio signals; and
processor circuitry communicatively connected to the memory, the processor circuitry to operate by:
receiving, by processor circuitry, intermodulation distortion product (IDP) audio signal data based on ultrasonic audio signals received by at least one microphone of an audio device; and
comparing the IDP audio signal data to ultrasonic audio signal data of the ultrasonic audio signals; and
determining a plurality of susceptibility values based on the comparing, wherein individual ones of the plurality of susceptibility values indicate a probability of a different ultrasonic frequency that can cause a successful ultrasonic attack.

13. The system of claim 12, wherein the susceptibility value is a weighted average sound pressure level (SPL) difference between the ultrasonic audio signal data and the audible IDP audio signal data.

14. The system of claim 13, wherein weighting of the weighted average SPL difference emphasizes frequencies used by human speech.

15. The system of claim 12, wherein the ultrasonic audio signals comprises two pure ultrasonic tones with a difference in frequency in an audible frequency band.

16. The system of claim 12, wherein the processor circuitry is arranged to operate by comparing the susceptibility value to a threshold.

17. At least one non-transitory computer readable medium comprising a plurality of instructions that in response to being executed on a computing device, causes the computing device to operate by:
receiving, by processor circuitry, intermodulation distortion product (IDP) audio signal data based on ultrasonic audio signals received by at least one microphone of an audio device; and
comparing the IDP audio signal data to ultrasonic audio signal data of the ultrasonic audio signals; and
determining an ultrasonic attack susceptibility of the audio device based on the comparing, and comprising determining a plurality of susceptibility values, wherein individual ones of the plurality of susceptibility values indicate a probability of a different ultrasonic frequency that can cause a successful ultrasonic attack.

18. The medium of claim 17, wherein the comparing comprises converting a sensitivity of the sound pressure level (SPL) of the IDP audio signal data to generate scaled SPL in a scale of a reference SPL of the ultrasonic audio signal data, and comparing the scaled SPL of the IDP audio signal data to the reference SPL of the ultrasonic audio signal data.

19. The medium of claim 17, wherein the comparing comprises comparing SPL of the IDP audio signal data to SPL of the ultrasonic audio signal data, wherein the smaller the difference in SPL, the more likely an ultrasonic attack will be successful.

20. The medium of claim 17, wherein the instructions are arranged to cause the computing device to operate by comparing the susceptibility values to a threshold of −30 dB.
